(19) United States
(12) Patent Application Publication
(10) Pub. No.: US 2011/0077968 A1
(43) Pub. Date: Mar. 31, 2011

(54) GRAPHICALLY REPRESENTING PHYSIOLOGY COMPONENTS OF AN ACUTE PHYSIOLOGICAL SCORE (APS)

(75) Inventors: LISA KELLY, OVERLAND PARK, KS (US); MAUREEN STARK, BEL AIR, MD (US); KATHY HENSON, LEE'S SUMMIT, MO (US); LISA MANGANARO, LEE'S SUMMIT, MO (US)

(73) Assignee: CERNER INNOVATION INC., OVERLAND PARK, KS (US)

(21) Appl. No.: 12/569,575

(22) Filed: Sep. 29, 2009

(51) Int. Cl. G06Q 50/00

(52) U.S. Cl. 705/3; 705/2

(57) ABSTRACT

Systems and methods for rendering a graphical object that visually represents those physiological components that account for a patient's acute physiology are provided. The method includes performing an acute physiology score (APS) calculation using diagnostic parameters to realize points associated therewith. The diagnostic parameters individually provide a measure of the patient's complete acute physiology. These points are combined to generate body-system scores that are values associated with each of the physiological components, respectively. Typically, the physiological components are predefined in number and each correspond with a respective body system. The method further includes the step of generating a graphical object that visually represents the body-system scores in an intuitive format, such as a pie graph. The graphical object is then rendered on a display device, and is presented in a bed gadget associated with a particular patient staying in the ICU.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Within the medical industry, service providers have employed a variety of tools (e.g., medical devices) to facilitate observation and/or treatment of a patient. Recently, some of these medical devices have been placed in communication with a local display device (e.g., bedside monitor) that provides an indication of the patient's health status on a primitive user interface (UI). Generally, the information rendered on the display device is unanalyzed and rudimentary. As such, the patient's health status must be gleaned from visual representations of unrefined measurements taken by the medical devices and other inputs that provide the patient's health status.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

There are various drawbacks of the primitive UI that is presented on the display device. Primarily, the information gathered from the patient is not consolidated into a value that allows the patient's clinician to easily discern a present health status of the patient or whether the patient's treatment is effective. That is, there is no single indication that explains why the patient is improving or getting worse throughout their intensive care unit (ICU) stay. Further, the information from the medical devices and other inputs is not analyzed in such a way that a clinician, at a glance, can identify which body system(s) of the patient are principally contributing to the patient's health status. Even further, the primitive UIs have not been aggregated to a bed-board display that includes a consolidated value of the patient's health status and an indication of the body system(s) driving that value alongside the values of all other patients in the ICU.

Accordingly, employing a process to identify which body system(s) are driving a health status of a patient, to derive a value of the patient's health status based on the body system(s) that are failing, and to present a representation of the identified body system(s) and the derived value on a bed-board display, along with similar information pulled from other beds in an ICU, would enhance the quality of care provided to each patient and provide an efficient way to assess the expected stay of the patient, the reason for the patient's improvement/decline in health, and the type of resources (e.g., beds, nurses, and medical devices) at the present and in a future timeframe.

Embodiments of the present invention provide systems and a methodology that measures a health status of, and predicts a hospital-stay outcome for, critically ill adult patients cared for in an intensive care unit (ICU) during their hospital stay. Initially, the methodology employs medical devices and other clinical assessment techniques to measure physiological derangements of a patient. Then, computing device(s), using the data used to compute physiological derangement, generate assessments of the likelihood that a patient will survive the ICU stay and/or the hospital stay. Also, the computing device will predict a timeframe of the expected ICU and hospital stays. Utilizing this information, an analytical process can be employed to develop an acute physiology score (APS) that represents a patient's health status. Generally, the APS is based on a condition of body systems (i.e., physiological components) that are targeted as the most influential in effecting the patient's health status.

Next, the analytical process may render the APS and values assigned to the physiological components on a bed-board display area within a graphical user interface (GUI) presented at a display device. In an exemplary embodiment, the APS and physiological component values may be presented in a bed gadget associated with the patient from whom the APS and physiological component values are measured. Typically, the bed gadget is configured to update in real-time as the health status of the patient changes.

Advantageously, the analytical process described above provides a prognostic scoring system that measures and communicates disease severity for purposes of assessment. Further, the configuration of the bed gadget(s) on the bed-board display promote improved patient care quality and survival rates, and enhanced operational efficiencies. The improved care quality assists in reducing treatment errors and healthcare costs (e.g., hospitals would make more efficient use of ICU beds). Further, the APS, upon combining with other factors (e.g., age, chronic conditions, disease group, and the like), can be used to generate expected outcomes across patients enabling hospitals to judge how well each ICU performs with respect to patient survivability and resource utilization.

More particularly, a first aspect of an embodiment includes one or more computer-readable media accommodated by a computing device. Generally, the computer-readable media may support computer-useable instructions that, when executed, perform a method for rendering a graphical object (e.g., pie chart) that visually presents those physiological components that account for a patient's acute physiology (constituting the APS). Initially, the method includes the step of performing an APS calculation by inputting one or more diagnostic parameters to realize points associated with each of the diagnostic parameters. Typically, the diagnostic parameters individually provide a measure of the patient's acute physiology. Next, the method involves combining the points to generate at least one body-system score, where each body-system score represents a value associated with each of the physiological components. The graphical object is then generated that graphically represents the body-system scores in an intuitive format. The graphical object may be rendered, in association with an indicia of the patient, on a display device.

This process described above it typically employed while the patient is staying at the hospital. Upon the patient leaving the hospital, systems of the present invention aim to aggregate these assessments across patients in order to compare what should occur (the predicted ICU stay and/or the hospital stay) to what actually happened (the actual ICU length of stay and/or the hospital length of stay).

In a second aspect, embodiments are directed toward a computer system for automatically tracking an inventory of beds residing in an ICU by calculating the APS for each patient that occupies one of the beds. Generally, the computer system includes a processor coupled to a computer-readable medium, the computer-readable medium having stored thereon a plurality of computer software components executable by the processor. These computer software components include, at least, a receiving component, an APS computing component, and a rendering component. Initially, the receiving component is configured to measure one or more diagnostic parameters of each patient that occupies one of the beds in the ICU. As discussed more fully below, the diagnostic parameters indicate a derangement of a particular body system.

The APS computing component is configured to perform an analytical process for calculating a body-system score associated with physiological components of the APS. In embodiments, the analytical process includes at least the following steps, in no particular order: (a) realizing points associated with each of the diagnostic parameters upon performing an APS calculation thereon; (b) aggregating the points realized for each of the diagnostic parameters that are members of a group, where the group is formed of the diagnostic parameters that correspond with the particular body system; and (c) designating the aggregated points as the body-system score associated with the one of the physiological components. In other embodiments, the computing component is further configured to calculate the APS by adding the body-system score associated with each of the physiological components together. As mentioned above, the APS provides an indication of an overall disease severity of the patient.

The computer software components stored on the computer-readable medium may also include a rendering component configured to render a bed gadget. In one instance, the bed gadget publishes the APS in proximity with a graphical representation of the body-system score associated with each of the physiological components, respectively. In another instance, the rendering component is further configured to render the graphical object as a pie graph, where the pie graph is proportionally divided based on the body-system score associated with each of the physiological components. Further yet, the rendering component may be further configured to present a bed-board display that posts bed gadgets associated with each of the beds in the ICU, respectively, and a key. Generally, each body system is assigned a consistent, non-repeating color. As such, the key articulates which consistent, non-repeating color is assigned to each of the physiological components.

A further aspect of an embodiment takes the form of computer-readable media, with computer-executable instructions embodied thereon, that is capable of presenting a GUI on one or more display devices. In general, the GUI is configured to present a plurality of bed gadgets that are each associated with one bed in an ICU. The GUI includes a bed-board display area that is populated with the plurality of bed gadgets representing each of the beds in the ICU. Typically, each of bed gadgets publishes a pie graph that is proportionally divided according to values attached to physiological components, where the physiological components are predefined in number and each correspond with a respective body system upon which the body system is assigned a consistent, non-repeating color. With reference to the pie graph that is divided by body system, the values attached to the physiological components associated with each body system are derived by performing an APS calculation on the diagnostic parameters (e.g., measurements of the patient's acute physiology). The “grouping” is based on the respective body system being measured by the diagnostic parameters in the group. Finally, the GUI may include a key that is configured to articulate which consistent, non-repeating color is assigned to each body system.

Accordingly, the bed-board display area of the GUI and the gadgets that make up the bed-board display area provide considerable value to clinicians (i.e., physicians and nurses). First, the bed-board display area provides value to physicians by allowing the physicians to quickly identify the body system(s) that are most significantly contributing to the patient's severity of illness via the physiological component values in the pie graph. As such, the physicians can easily prioritize by body system(s) the factors contributing to the patient's physiologic derangements. Further, the physicians can monitor how the physiology of the patient has changed in the last days/weeks/months in order to evaluate the history of the patient's acuity and his/her responses to certain therapies. Second, the bed-board display area provides value to nurses by providing concurrent and trended assessments of patient acuity to facilitate quality nursing care by assisting them to objectively evaluate the impact of their nursing interventions on patient outcomes.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is a block diagram of an exemplary computing environment suitable for use in implementing embodiments of the present invention;

FIG. 2 is an exemplary system architecture suitable for use in implementing embodiments of the present invention;

FIGS. 3-7 are illustrative screen displays showing exemplary user interfaces, in accordance with embodiments of the present invention;

FIG. 8 is an illustrative flow diagram of a method for rendering a graphical object that visually presents those physiological components that account for a patient's acute physiology, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Embodiments provide systems, user interfaces (UI's), graphical user interfaces (GUI's) and computer-readable media for, among other things, presenting a patient's information on an individual bed gadget within display area. Generally, the display area includes a layout of bed gadgets that correspond to each of the beds available and that are used within an intensive care unit (ICU). Each of the presented bed gadgets within the layout have graphical objects therein that express details of a patient's condition, trends related to the patient's health status, and outcome predictions of the patient's stay in the ICU and/or hospital. Accordingly, the outcome predictions for each of the patients residing in the ICU are presented in a single view in a UI, thereby assisting clinicians to readily identify patients who have the highest risk of mortality who may need the greatest amount of care, patients who have been inappropriately admitted to the ICU and those patients who may be acceptable candidates for transfer out of the ICU.

Having briefly described embodiments of the present invention, an exemplary operating environment suitable for use in implementing embodiments of the present invention is described below.

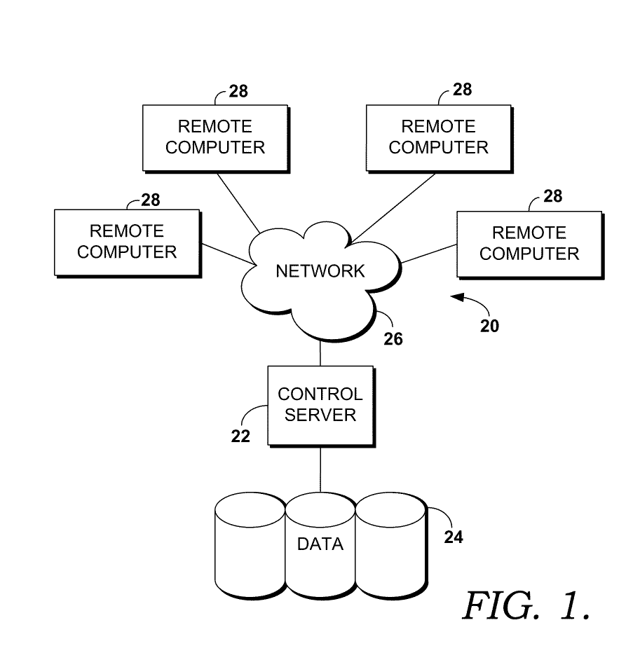

Referring to the drawings in general, and initially to FIG. 1 in particular, an exemplary computing system environment, a medical information computing system environment, with which embodiments of the present invention may be implemented is illustrated and designated generally as reference numeral 20. It will be understood and appreciated by those of ordinary skill in the art that the illustrated medical information computing system environment 20 is merely an example of one suitable computing environment tended to suggest any limitation as to the scope or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in association with local and/or remote computer storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer-readable media, for instance, database cluster 24. Computer-readable media can be any available media that may be accessed by server 22, and includes volatile and nonvolatile media, as well as removable and non-removable media. By way of example, and not limitation, computer-readable media may include computer storage media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 22. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 24, provide storage of computer-readable instructions, data structures, program modules, and other data for the control server 22. The control server 22 may operate in a computer network 26 using logical connections to one or more remote computers 28. Remote computers 28 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the elements described above in relation to the control server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in association with the control server 22, the database cluster 24, or any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) may be utilized.

In operation, a clinician may enter commands and information into the control server 22 or convey the commands and information to the control server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 22. In addition to a monitor, the control server 22 and/or remote computers 28 may include other peripheral output devices, such as speakers and a printer.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

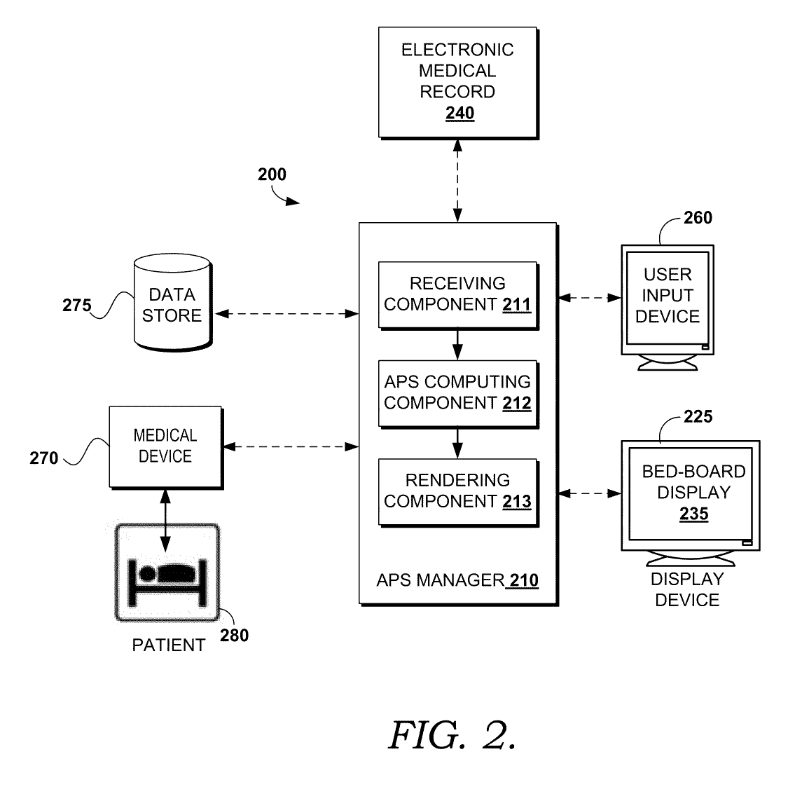

An exemplary system architecture 200 suitable for use in implementing embodiments of the present invention will now be discussed with reference to FIG. 2. Generally, the exemplary system architecture 200 provides a platform within a healthcare network for generating an APS for one or more patients staying in an ICU and for rending the APS in bed gadgets associated with each of the patients, respectively. Further, the platform is used to manage a patient's treatment and to properly allocate resources (e.g., beds and medical equipment).

It will be appreciated that the computing system architecture shown in FIG. 2 is merely an example of one suitable computing system and is not intended as having any dependency or requirement related to any single component or combination of components.

The exemplary system architecture 200 includes a variety of interconnected devices and software suitable for use in implementing embodiments of the present invention. Initially, in embodiments, the exemplary system architecture 200 includes an APS manager 210, a display device 225, an electronic medical record 240, a user input device 260, a medical device 270, and a data store 257. In addition, APS manager 210 accommodates computer-readable media that supports a receiving component 211, an APS computing component 212, and a rendering component 213. It should be understood that this and other arrangements described herein are set forth only as examples. Other arrangements and elements (e.g., machines, interfaces, functions, orders, and groupings of functions, etc.) can be used in addition to, or instead of, those shown, and some elements may be omitted altogether. Further, many of the elements described herein are functional entities that may be implemented as discrete or distributed components or in conjunction with other components, and in any suitable combination and location. Even further, various functions described herein as being performed by one or more entities (e.g., devices, components, and the like) may be carried out by hardware, firmware, and/or software.

The medical device 270 may be any device, stationary or otherwise, that may be used to treat or monitor the health of a patient in an ICU, hospital, or physician's office, and may be useful for diagnostic and therapeutic purposes. For exemplary purposes only and not limitation, medical devices include heart rate monitors, blood pressure monitors, uterine pressure and contraction activity monitors, blood oxygen saturation monitors, ventilators, thermometers, a patient's bed, sequential compression devices, electronic security devices, and instruments with software to carry out their proper purposes on an intended subject. The intended purposes of the medical device 270 include one or more of the following: diagnosis; prevention; monitoring; treatment or alleviation of disease; compensation for an injury or handicap; investigation; or replacement or modification of the anatomy or of a physiological process. Although one medical device 270 is shown, any number of devices may be employed to achieve the desired functionality within the scope of embodiments of the present invention.

In operation, the medical device 270 serves to collect data that reflects the current health status of the patient. In one embodiment, the data may take the form of diagnostic parameters, which describe a current status of the patient. The phrase “diagnostic parameters,” as used herein, is not meant to be limiting, but may broadly encompass any measurements that indicate a health of a particular body system of a patient 280 and may encompass a large range information that relates to the overall health status of the patient 280 or the treatment thereof. Accordingly, the diagnostic parameters provided by medical device 270 are generally utilized to dynamically monitor the patient 280 during a stay in an ICU. By way of example, the diagnostic parameters may include any one or more of the following: acute physiological variables; vital signs; age; chronic health history (e.g., pre-existing medical problems); disease progression; abnormalities on admission; diagnosis when entering ICU; patient temperature; blood pressure; and heart rate. In one instance, the diagnostic parameters are sent from the medical device 270 to the receiving component 211, which passes the diagnostic parameters to the APS computing component 212 for analysis.

The electronic medical record (EMR) 240 is generally provided to store and allow access to a variety of information and data related to the patient 280. As utilized herein, the acronym “EMR” is not meant to be limiting, and may broadly refer to any or all aspects of the patient's medical record rendered in a digital format. Generally, the EMR is supported by systems configured to coordinate the storage and retrieval of individual records with the aid of computing devices. As such, a variety of types of healthcare-related information may be stored and accessed in this way. By way of example, the EMR may store one or more of the following types of information: patient demographic; medical history (e.g., examination and progress reports of health and illnesses); medicine and allergy lists/immunization status; laboratory test results, radiology images (e.g., X-rays, CTs, MRIs, etc.); evidence-based recommendations for specific medical conditions; a record of appointments and physician's notes; billing records; and data received from an associated medical device. Accordingly, systems that employ EMRs reduce medical errors, increase physician efficiency, and reduce costs, as well as promote standardization of healthcare.

In operation, data or relevant content may be extracted from the EMR 240 of the patient 280 and transmitted to the receiving component 211. In one embodiment, the relevant content includes the diagnostic parameters that indicate previously recorded physical attributes of the patient 280, as described above.

The user input device 260 may comprise any of the input devices described above with reference to FIG. 1, such as a keyboard, a pointing device (commonly referred to as a mouse), a trackball, or a touch pad. Generally, the user input device is configured to gather information (e.g., medical annotations) during an admission assessment upon admitting the patient 280 to a hospital. This information may be conveyed to the receiving component 211 in the form of diagnostic parameters that characterize a condition of the patient 280 upon admittance to a hospital.

When conducting the admission assessment, the information that is entered at the user input device 260 may include an admit source. Generally, the admit source relates to where the patient 280 came from, such as a surgical source (e.g., OR) or a medical source (e.g., general care floor). In embodiments, a nurse may enter this information while recording information at the patient's bedside. Upon selecting the admit source, additional data related to the patient's body systems is entered. In an exemplary embodiment, the body system data is filtered by which admit source is selected. That is, only those diagnoses that are relevant to the selected admit source are available for entry, while unrelated diagnoses are restricted from entry, thereby incorporating a safeguard into the receiving component 211 that reduces incorrect entries upon admission of the patient 280.

By way of example, if the admit source is a surgical source (e.g., the patient 280 is coming from the operating room or post-anesthesia care), only those categories/body systems and subcategories/parameters relevant to a surgical diagnosis are listed for selection. In another example, if the admit source is a medical source (e.g., the patient 280 is coming from the general care floor upon suffering a disease), only those categories/body systems and subcategories/parameters relevant to a non-operative diagnosis are listed for selection. As such, errors are reduced by focusing the input choices in accordance with the admit source.

In embodiments, the display device 225 may be operably coupled to an output of the APS manager 210, may be configured as any presentation component that is capable of presenting information to a user, such as a digital monitor, electronic display panel, touch-screen, analog set top box, plasma screen, computer screen, projection device, or other hardware devices. In operation, the display device 225 is capable of displaying graphical user interfaces (GUI's). Often the display device is coupled to or integrated with a computer processor to facilitate display of the GUI's. The GUI's may include a presentation of a bed-board display 235 that presents information regarding a condition of the patient 280 in a bed gadget alongside other bed gadgets that populate the bed-board display 235. In addition, the GUI's may provide information related to patient alerts, medical charts, and graphical depictions of a patient's health. Although depicted as being physically coupled to the APS manager 210, the display device 225 may be remotely located therefrom, such as on a wall of the ICU. Further, although the display device 225 is illustrated as a single element, a plurality of display devices that each render GUI's are contemplated by embodiments of the present invention.

The data store 275 is generally configured to store, at a memory location, data generated and conveyed from at least one of the medical device 270, the EMR 240, and the user input device 260, as well as the APS manager 210. In addition, the data store 275 may be configured to be searchable for, or provide suitable access to, the data stored thereon. It will be understood and appreciated by those of ordinary skill in the art that the information stored in the data store 275 may be configurable and may include any information relevant to the processes executed to achieve proper execution of the system architecture 200. The content and volume of such information are not intended to limit the scope of embodiments of the present invention in any way. Further, though illustrated as a single, independent component, the data store 275 may, in fact, be a plurality of databases, for instance, a database cluster, portions of which may reside on one or more of the devices of the system architecture 200.

In various embodiments, the data stored at the data store 275 may include, without limitation, the diagnostic parameters (i.e., measurements attained by monitoring the patient 280 that characterize physiological attributes thereof), and a core dataset. In embodiments, the “core dataset” relates to computerized experiences of a multitude of patients visiting an ICU. These computerized experiences may be built by acquiring and analyzing treatment outcomes within the context of physiological attributes of the past patients.

In operation, the core data set may be utilized to establish and update an APS calculation, and in particular, reference points that are listed within the APS calculation. Generally, each of the reference points represent a benchmark measurement of ICU patient populations. Accordingly, the body-system score (value associated with each of the physiological components) may be computed by iteratively ascertaining a deviation between each of diagnostic parameters and an associated reference point, and awarding APS points to each of the diagnostic parameters based on the deviation, where the greater the deviation, the higher the number of APS points awarded. Typically, the reference points and the APS points associated with each deviation are derived from the core dataset.

The APS manager 210 may reside on one or more computing devices, such as, for example, computing device 22 described above with reference to FIG. 1. By way of example only and not limitation, computing devices may be a server, personal computer, desktop computer, laptop computer, handheld device, mobile handset, consumer electronic device, or the like. It should be noted, however, that embodiments are not limited to implementation on such computing devices, but may be implemented on any a variety of different types of computing devices within the scope of embodiments thereof.

As discussed above, components are provided that underlie the operation of the APS manager 210. Exemplary components may include the receiving component 211, the APS computing component 212, and the rendering component 213. In operation, the monitoring component 211 is configured to receive measured physiological attributes of the patient 280 from the medical device 270, the EMR 240, and the user input device 260, as well as to receive other detected medical events, in the form of the diagnostic parameters. The receiving component 211 may be further configured to communicate information related to the diagnostic parameters to the APS computing component 212.

The APS computing component 212, in embodiments, is configured to perform an analytical process for calculating body-system scores associated with physiological components of the APS as well as the APS. As utilized herein, the phrase “acute physiological score” (APS) provides an indication of an overall disease severity of a patient. In one instance, the APS is comprised, in part, of body-system scores assigned to physiological components that each represent a respective body system and that each account for the patient's acute physiology. In this instance, when rendered, the APS may be graphically represented as a pie graph that is divided according to the body-system scores assigned by the physiological components comprising the APS. As such, the pie graph shows the main contributing body system(s) that are driving the APS. Advantageously, the pie graph clearly articulates the patient's disease severity by stratifying, or breaking down, the patient's malady across body systems and enhances the decision-making process with respect to the patient's further treatment. In other words, the pie graph allows a clinician (e.g., physician, nurse, and other medical personal) to efficiently identify those factors that contribute to the outcome of the patient, whether it be improvement or decline.

As described above, the pie chart, or other stratified graphical representation of the APS, is divided according to physiological components. As utilized herein, the phrase “physiological component” is not meant to be limiting, but may be any factors that can be used to breakdown a patient's complete acute physiology or overall disease severity, represented by the APS, into various physiological systems. Further, the physiological components may take any number of forms and may be displayed in various types of graphical representations.

In one instance, the physiological components correspond to logical body-system-type groupings. By way of example, each of the physiological components are associated with one of six predefined body systems that are assigned a maximum point value: Hemodynamics/Cardio Vascular (54 points); Pulmonary/Respiratory (45 points); Central Nervous System/Neuro (48 points); Renal (37 points); Infectious Disease (39 points); and Hepatic/Metabolic (29 points). Accordingly, when a patient exhibits further deterioration in one or more of the physiological components, the APS is updated to reflect the further deterioration. Further, the pie graph is reconfigured to reflect the failure or change as well. Accordingly, because the physiological components provide a condensed indication of the measurements taken while monitoring a patient, a graphical representation of the physiological components (e.g., pie graph), allows physicians to quickly ascertain which body system is contributing the most to the current health status of the patient.

One method utilized by the APS computing component 212 to calculate the body-system scores and the APS will now be discussed. This method may be performed real-time or at a pre-designated time in the future. Initially, information related to the diagnostic parameters may be received from the receiving component 211. Next, an analytical process is commenced for calculating a body-system score associated with each of the physiological components of the APS. Initially, the analytical process involves applying an APS calculation to the diagnostic parameters in order to realize points associated with each of the diagnostic parameters. The APS calculation is a tool that is based on case studies and medical history patterns of thousands of previous adult ICU patients, such as those stored in the core dataset maintained by the data store 275. In one instance, the medical history patterns are based on patient data captured in the same or another hospital. Generally, these medical history patterns track fluctuations in health status measurements to provide an understanding of what has contributed to improvements in and/or degradation of an adult ICU patient's health. In one instance, medical history patterns may be stored within the core dataset. From the previous case studies and the medical history patterns, reference points may be established and stored with reference to the APS calculation. As used herein, the phrase “reference point” represents a benchmark measurement or metric associated with a characteristic of a typical adult ICU patient. By way of example, a reference point related to an internal temperate metric might be 100.4 degrees Fahrenheit with a deviation thereabout, or a range of 96.8-103.9 degrees Fahrenheit.

Often the APS calculation uses a schedule for determining the amount of APS points to assign to a particular diagnostic parameter. Depicted below in Table 1 is an example schedule that may be employed when conducting the APS calculation.

TABLE 1

| Diagnostic | Midpoint (i.e., | | | |
|---|---|---|---|---|
| Parameter | reference point) | Ranges | APS Points | Comments |
| Core | (100.4) | <92 | 20 | |
| Temperature | | 92.0-92.2 | 16 | |
| | | 92.3-93.1 | 13 | |
| | | 93.2-94.9 | 8 | |
| | | 95.0-96.7 | 2 | |
| | | 96.8-103.9 | **0 | |
| | | ≧104 | 4 | |
| Mean Blood | (90) | <40 | 23 | |
| Pressure | | 40-59 | 15 | |
| | | 60-69 | 7 | |
| | | 70-79 | 6 | |
| | | 80-99 | **0 | |
| | | 100-119 | 4 | |
| | | 120-129 | 7 | |
| | | 130-139 | 9 | |
| | | ≧140 | 10 | |
| Heart Rate | (75) | <40 | 8 | |
| | | 40-49 | 5 | |
| | | 50-99 | **0 | |
| | | 100-109 | 1 | |
| | | 110-119 | 5 | |
| | | 120-139 | 7 | |
| | | 140-154 | 13 | |
| | | ≧155 | 17 | |
| Respiratory Rate | (19) | ≦5 | 17 | (No points if vented |
| | | 6-11 | 8 | for RR 6-12) |
| | | 12-13 | 7 | |
| | | 14-24 | **0 | |
| | | 25-34 | 6 | |
| | | 35-39 | 9 | |
| | | 40-49 | 11 | |
| | | ≧50 | 18 | |
| Urine | | ≦399 | 15 | |
| Output | | 400-599 | 8 | |
| | | 600-899 | 7 | |
| | | 900-1499 | 5 | |
| | | 1500-1999 | 4 | |
| | | 2000-3999 | **0 | |
| | | ≧4000 | 1 | |
| WBC | (11.5) | <1.0 | 19 | |
| | | 1.0-2.9 | 5 | |
| | | 3.0-19.9 | **0 | |
| | | 20-24.9 | 1 | |
| | | ≧25 | 5 | |
| HCT | (45.5) | ≦40.9 | 3 | |
| | | 41-49 | **0 | |
| | | ≧50 | 3 | |
| Sodium | (145.5) | ≦119 | 3 | |
| | | 120-134 | 2 | |
| | | 135-154 | **0 | |
| | | ≧155 | 4 | |
| BUN | | ≦16.9 | **0 | |
| | | 17-19 | 2 | |
| | | 20-39 | 7 | |
| | | 40-79 | 11 | |
| | | ≧80 | 12 | |
| Creatinine | (1.0) | 0-1.4 | **0 | (ARF defined as |
| | | | | CR >= 1.5 mg/dl |
| | | ≧1.5 | 10 | and U/O < 410 |
| | | | | and Dialysis = No) |
| | | ≦0.4 | 3 | (Use when |
| | | | | above |
| | | 0.5-1.4 | **0 | conditions |
| | | 1.5-1.94 | 4 | not met) |
| | | ≧1.95 | 7 | |
| Glucose | (130) | ≦39 | 8 | |
| | | 40-59 | 9 | |
| | | 60-199 | **0 | |
| | | 200-349 | 3 | |
| | | ≧350 | 5 | |
| Albumin | (3.5) | ≦1.9 | 11 | |
| | | 2.0-2.4 | 6 | |
| | | 2.5-4.4 | **0 | |
| | | >4.5 | 4 | |
| Bilirubin | | ≦1.9 | **0 | |
| | | 2.0-2.9 | 5 | |
| | | 3.0-4.9 | 6 | |
| | | 5.0-7.9 | 8 | |
| | | ≧8.0 | 16 | |
| AaDO2 | | <100 | **0 | (Intubated and FiO2 |
| | | 100-249 | 7 | >= 50%) |
| | | 250-349 | 9 | |
| | | 350-499 | 11 | |
| | | ≧500 | 14 | |
| Pa02 | | ≦49 | 15 | (Use when |
| | | 50-69 | 5 | above |
| | | 70-79 | 2 | conditions |
| | | ≧80 | **0 | not met) |

In embodiments, the APS calculation includes the following steps: accessing the reference points associated with each of the diagnostic parameters from the schedule; iteratively ascertaining a deviation between each of diagnostic parameters and the associated reference points; and awarding points to each of the diagnostic parameters based on the deviation. Generally, the greater the deviation, the higher the number of points that are awarded. It has been ascertained that by using reliable data in the core dataset, the points awarded upon implementing the APS calculation reach a prognosis that is 95% accurate.

By way of example, the APS calculation will now be discussed with reference to the diagnostic parameter of internal temperature measured from the patient 280. Initially, the portion of the schedule that references internal temperature is queried. The following schedule in Table 2 represents an exemplary portion of the APS calculation that references the internal temperature.

TABLE 2

| Internal Temperate Range | APS Points |
|---|---|
| <92 | 20 |
| 92.0-92.2 | 16 |
| 92.3-93.1 | 13 |
| 93.2-94.9 | 8 |
| 95.0-96.7 | 2 |
| 96.8-103.9 | 0 |
| >104 | 4 |

Next, the measured internal temperature is mapped to the schedule to determine the most deviant value from the reference point, where the reference point is the range of 96.8-103.9 degrees Fahrenheit. If, for instance, the measured internal temperature is 92.5 degrees Fahrenheit, the APS points assigned to the diagnostic parameter of internal temperature is 13. Because the internal temperature of the patient relates to the particular body system of “Infectious Disease,” those other diagnostic parameters grouped based on that particular body system are assigned APS points by performing the APS calculation as well.

If the internal temperature of the patient 280 deviates further from the reference point, then the points awarded the diagnostic parameter of internal temperature are increased and the associated body-system score for Infectious Disease is comparatively increased. However, if the internal temperature of the patient 280 moves closer to the reference point, then the points awarded the diagnostic parameter of internal temperature are left unchanged. As such, the points awarded to the body-system scores for each of the physiological components of the ASP represent the worst conditions during a predefined timeframe. In one instance, the predefined timeframe may be a 24-hour period. In another instance, the predefined timeframe may vary during the course of the patient's 280 stay (e.g., a period of 8-32 hours upon admittance for a first day and 24 hours thereafter for the subsequent days). In other embodiments, any change in the diagnostic parameters cause a change in the associated body-system score(s).

Upon determining the points awarded for each of the diagnostic parameters that are grouped according to the particular body system, Infectious Disease, the awarded points are combined to arrive at body-system score(s). As discussed above, the body-system score(s) are values attached to each of the physiological components, respectively. In one instance, arriving at a body-system score involves aggregating the points realized for each of the diagnostic parameters that are members of the group associated with a particular physiological component, and designating the aggregated points as the body-system score associated with the particular physiological component. For instance, with reference to Infectious Disease example above, the aggregated points would include the 13 points awarded to the diagnostic parameter of internal temperature.

Upon determining the APS points for the diagnostic parameters and assigning a value, or body-system score, to each of the physiological component, the APS calculation further involves adding the body-system scores together to arrive at the APS. As discussed above, the APS provides a readily identifiable, overall disease severity metric of the patient 280. Based on the initial APS, the updated APS, the body-system scores, and other information, a risk of death of the patient 280 while staying in the ICU and/or the hospital may be derived. Further, a predicted length of the stay in the ICU and/or the hospital may be derived from this information. Further yet, additional predictive metrics, such as a predicted nursing care workload, may be calculated using the information derived above.

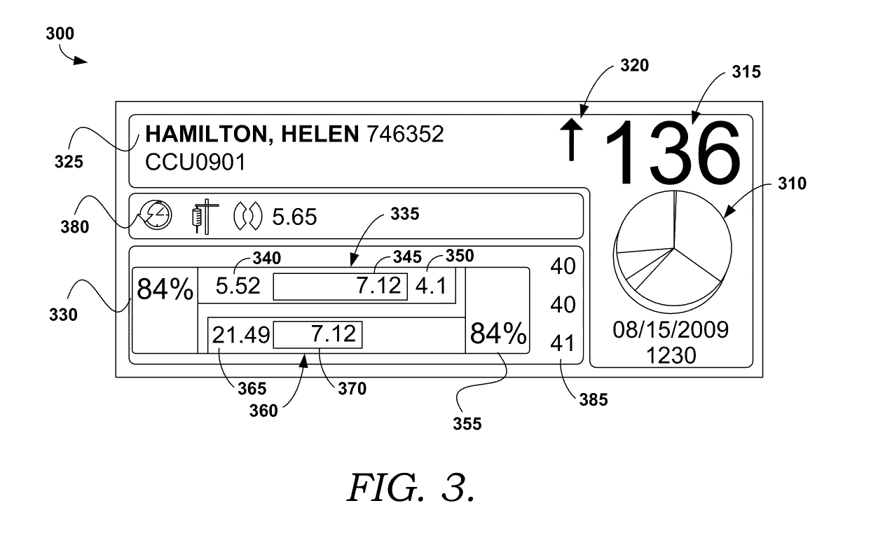

This information (APS points, body-system score, and the like) derived above utilizing the analytical process and the APS calculation may be communicated from the APS computing component 212 to the rendering component 213. The rendering component 213 may then perform processes to make the clinicians aware of the health status of the patient 280. These processes involve generating a graphical object that graphically represents the body-system score generated for each of the physiological components in an intuitive format. In one embodiment of generating the graphical object, with reference to FIG. 3 that illustrates an exemplary GUI, a graphical object that graphically represents the body-system scores is rendered as a pie graph 310 within a bed gadget 300 associated with the patient Helen Hamilton.

Further, upon receiving the body-system scores and the APS, the rendering component 213 is configured to render a bed gadget that publishes the APS in proximity with a graphical representation (e.g., pie graph) of the body-system scores. The bed gadget for the patient 280, shown in FIG. 3, is typically displayed in a layout with other bed gadgets within the bed-board display 235. As discussed above, the bed-board display 235 area is presented within a GUI generated by a display device 225.

This exemplary system architecture 200 of FIG. 2 is but one example of a suitable environment that may be implemented to carry out aspects of the present invention, and is not intended to suggest any limitation as to the scope of use or functionality of the invention. In some embodiments, one or more of the components 211, 212, and 213 may be implemented as stand-alone devices. In other embodiments, one or more of the components may be integrated directly into the one or more of the devices. It will be understood by those of ordinary skill in the art that the components 211, 212, and 213 illustrated in FIG. 2 are exemplary in nature and in number and should not be construed as limiting.

Further, the medical device 270, the EMR 240, the user input device 260, the bed-board display 235, as well as the APS manager 210 and the data store 275 (hereinafter the “elements” of the exemplary system architecture 200) of the healthcare network may be interconnected by any method known in the relevant field. For instance, the elements of the exemplary system architecture 200 may be operably coupled via a distributed communications environment supported by network 26 of FIG. 1. Advantageously, the elements of the exemplary system architecture 200 can automatically work in concert with each other and other medical devices, thus, significantly reducing or eliminating human error and variance in acute and chronic care management processes. In addition, the ability to wirelessly couple these elements together provides greater mobility for patients, thereby improving care management for patients in specialized care settings, such as the ICU and remote locations throughout the hospital.

An individual bed gadget will now be described with reference to FIG. 3. Initially, the bed gadget 300 includes an indicia 325 of the patient, Helen Hamilton, in a predominant position. Thus, the identity of the patient, for whom the information is displayed on the bed gadget 300, is readily discernable. Further, the pie graph 310 and the APS 315 are published in a predominate manner that is designed to draw the attention of the clinician reading the bed gadget 300. As shown, the APS 315 is rendered in proximity with the pie graph 310.

In one instance, the APS 315 may be accompanied by a symbol 320 that indicates a trend in the patient's health status. For instance, the symbol 320 may be an up-arrow to indicate the patient's health is declining, while a down-arrow may indicate a recent improvement in the patient's health. In another instance, the pie graph 310 is proportionally divided based on the body-system score associated with each of the physiological components (e.g., based on the six predefined body systems). In this instance, the physiological components contribute to a body system grouping which is assigned a consistent, non-repeating color, where a key (not shown) may be posted within the UI that articulates which non-repeating color is assigned to each body system. Accordingly, each section of the pie graph 310 will invariably display the color assigned to the body system that is represented by the section.

Although a pie-graph configuration of the graphical object representing the body-system scores has been described, it should be understood and appreciated by those of ordinary skill in the art that other types of suitable graphical objects that provide a stratified depiction of the main physiological components that drive the APS may be used, and that embodiments of the present invention are not limited to the pie graph 310 illustrated herein.

Also, the bed gadget 300 may include other information useful in assessing the stay of the patient in the ICU and/or the hospital, such as the risk of death and the length of stay, described more fully above. For instance, the predicted risk of death of the patient in the ICU and in the hospital may be calculated based, in part, on the APS. Generally, the risk of death metric indicates an individual's risk of dying either in the ICU or the hospital during a specific stay. Upon calculation, a first graphical object 330 that represents the predicted risk of death of the patient in the ICU may be rendered as a percentage. Also, a second graphical object 355 that represents the predicted risk of death of the patient in the hospital may be rendered as a percentage. As shown in FIG. 3, the first graphical object 330 and the second graphical object 355 are presented within a display area of the bed gadget 300.

In another instance, the predicted length of stay of the patient in the ICU and in the hospital are calculated based, in part, on the APS. Generally, the length of stay metric indicates a period of time that the patient is expected to remain in either the ICU or the hospital. Upon calculation, a third graphical object 335 that represents the predicted length of stay of the patient in the ICU is rendered as a timeframe. Also, a fourth graphical object 360 that represents the predicted length of stay of the patient in the hospital is rendered as a timeframe. As shown in FIG. 3, the third graphical object 335 and the fourth graphical object 360 are presented within the display area of the bed gadget 300.

In one embodiment, in an effort to ensure efficient readability and usability of the bed gadget 300, the predicted risk of death of the patient in the ICU, rendered as the first graphical object 330, and the predicted length of stay of the patient in the ICU, rendered as the third graphical object 335, are visually coupled. As illustrated in the bed gadget of FIG. 3, visually coupling is achieved by orientating the first graphical object 330 and the third graphical object 335 as a single block in a leftward portion of the display area.

In another embodiment, the predicted risk of death of the patient in the hospital, rendered as the second graphical object 355, and the predicted length of stay of the patient in the hospital, rendered as the fourth graphical object 360, are visually coupled. As illustrated in the bed gadget of FIG. 3, visually coupling is achieved by orientating the second graphical object 355 and the fourth graphical object 360 as a single block in a rightward portion of the display area. As such, a clinician can target a single block in the display area within the bed gadget 300 to ascertain either predictive information related to an ICU stay or a hospital stay. Advantageously, the clinician can determine how to allocate resources (e.g., beds) within the ICU at a glance.

Although an exemplary configuration of the arrangement of the risk of death and length of stay for the ICU and hospital has been described, it should be understood and appreciated by those of ordinary skill in the art that other types of suitable arrangements within the display area of the bed gadget 300 may be used, and that embodiments of the present invention are not limited to those graphical objects 330, 335, 355, and 360, as well as their orientation, described herein.

Further, the third graphical object 335 may include additional metrics, such as an actual length of stay in the ICU in terms of days 340, a predicted length of stay in the ICU in terms of days 340, and a reevaluated length of stay in the ICU in terms of days 350 (e.g., reevaluated on the fifth day in the ICU), based on the changes in the patient's health since admission. Further yet, the fourth graphical object 360 may include additional metrics, such as an actual length of stay in the hospital in terms of days 370 and a predicted length of stay in the hospital in terms of days 365.

In an exemplary embodiment, a color coding is associated with these above-discussed metrics to indicate whether the actual length of stay is lower than or equal to its predicted counterpart (e.g., designated as green) or greater than its predicted counterpart (e.g., designated as red). Further, the actual lengths of stay may be associated with a bar that increases in horizontal length to correspond with an expanding actual lengths of stay as compared to the predicted lengths of stay. Also, a color coding may be associated with the predicted risk of death to indicate a level of severity of the patient's health status. For instance, different colors may be used for each of low, moderate, and high levels of risk of death. If there are metrics that are non-predictive, then a white color coding scheme may be used.

With continued reference to FIG. 3, in embodiments, other features are presented in the bed gadget 300. In one instance, a type of treatment feature 380 is rendered. By way of example, the type of treatment feature 380 may include icons to convey specific information, such as whether the patient is being actively treated for a certain malady. In a second instance, a therapeutic intervention scoring system (TISS) feature 385 is rendered. By way of example, the TISS feature 385 may represent a measure of nursing care workload for the past, present, and future. Accordingly, the TISS feature is helpful in estimating expected nurse staffing requirements.

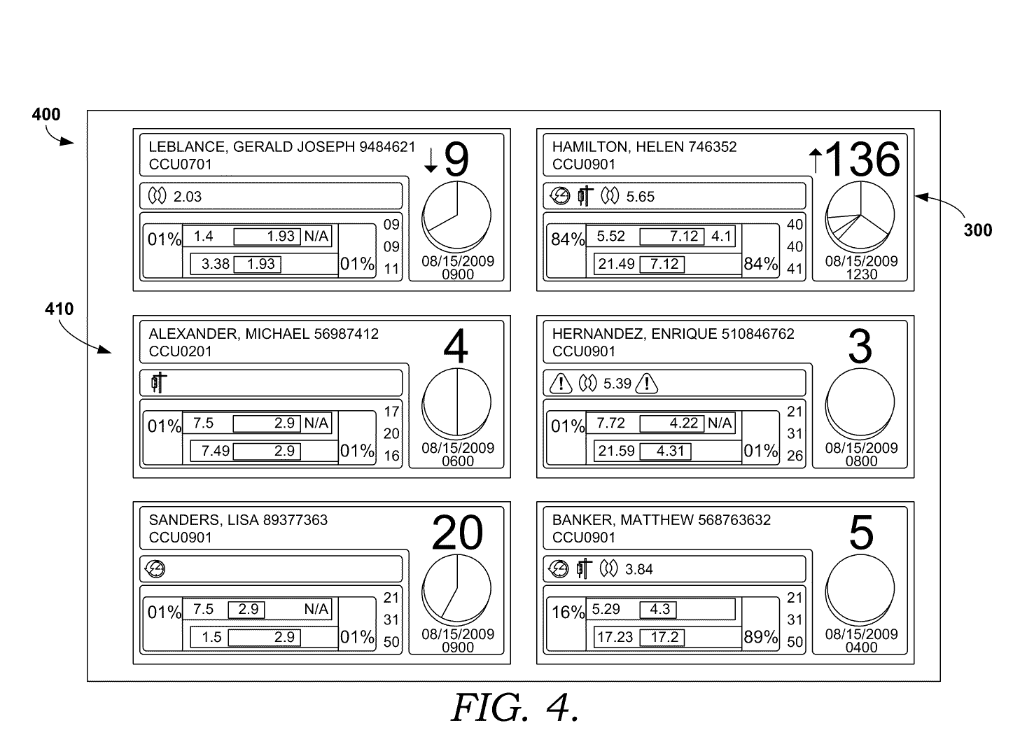

Turning now to FIG. 4, an exemplary UI is shown, in accordance with embodiments of the present invention, that includes a bed-board display area 400. Within the bed-board display area 400 are a plurality of bed gadgets 410, each associated with a particular bed and/or patient in the ICU. If a patient occupies a bed in the ICU there is an APS, graphical object, and features presented on the respective bed gadget, such as the bed gadget 300, that reflect the current and predicted health status of the patient. Otherwise, when the bed is unoccupied, the corresponding bed gadget is left featureless. In an exemplary embodiment, a layout of the of the bed gadgets 410 within the bed-board display area 400 indicates a physical location of the actual beds represented by each of the bed gadgets 410.

Although not shown, the bed-board display area 400 may include a key that explains the color coding of the risk of death and length of stay graphical objects, discussed more fully above. Further, the key may provide a color scheme that exposes the colors assigned to each of the body system groupings based on the physiological components of the APS.

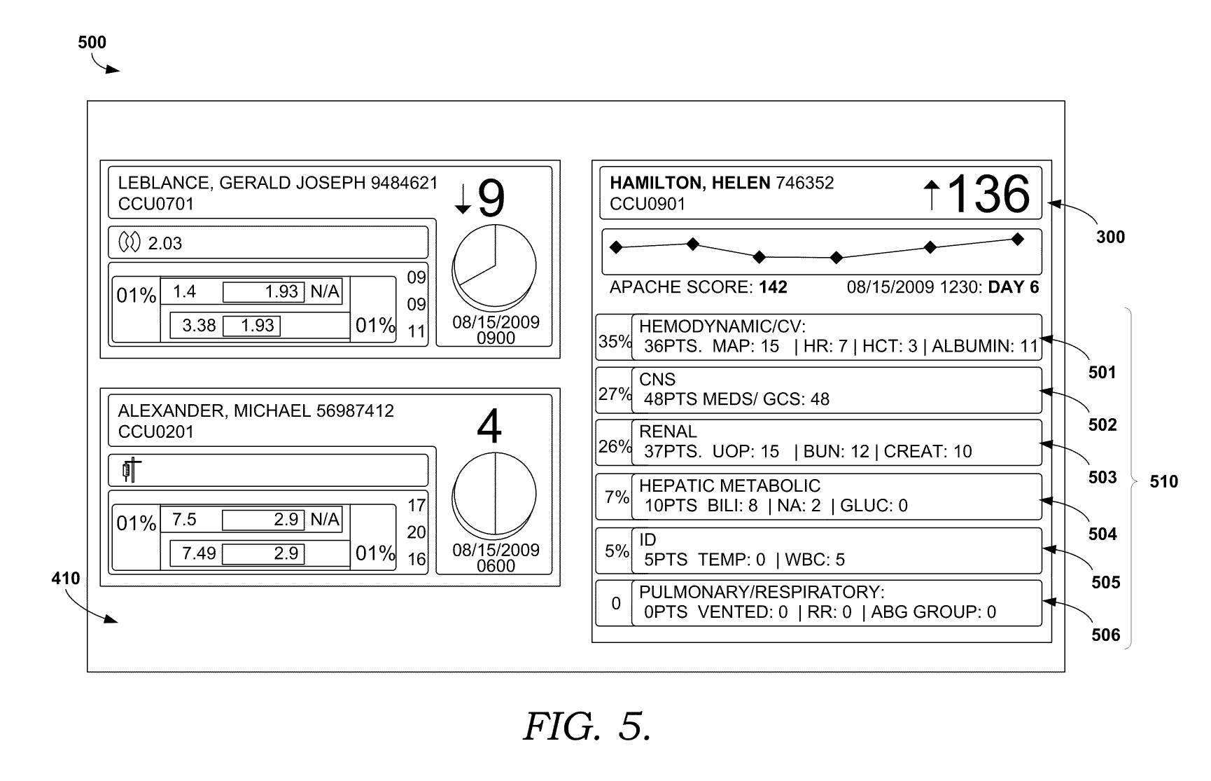

Turning now to FIG. 5, an exemplary UI is shown, in accordance with embodiments of the present invention, that includes a bed-board display area 500. Within the bed-board display area 500 are a plurality of bed gadgets 410, each associated with a particular bed in the ICU. Further, the bed gadget 300 is provided within the plurality of bed gadgets 410. In this embodiment, the bed gadget 300 includes a pop-up window 510 with a display area therein. This pop-up window 510 may be invoked by any operation provided by a clinician via a user interface input. In one instance, the operation may be a touch-type user action within a target zone on a touchscreen. In another instance, the operation may be a hover action of a mouse cursor over the bed gadget 300.

The display area of the pop-up window 510 is populated with a listing of body systems associated with the physiological components of the APS. Specifically, the list includes the above-discussed six predefined body systems: Hemodynamics/Cardio Vascular 510; Central Nervous System/Nero 502; Renal 503; Hepatic/Metabolic 504; Infectious Disease 505; and Pulmonary/Respiratory 506. Additionally, as discussed above, each of the predefined body systems is assigned a body-system score that is calculated by inputting those diagnostic parameters that are associated with a certain body system into an APS calculation. Generally, these body-system scores are graphically displayed in a pie graph. However, the pop-up window 510 provides the numerical value of the body-system scores: 36 points for Hemodynamics/Cardio Vascular 510; 48 points for Central Nervous System/Nero 502; 37 points for Renal 503; 10 points for Hepatic/Metabolic 504; 5 points for Infectious Disease 505; and 0 points for Pulmonary/Respiratory 506.

Also, the pop-up window 510 presents a complete breakdown of how the body-system scores and the APS are derived. That is, the diagnostic parameters, as well as their calculated APS points, are shown in proximity to each associated body system. For instance, for the body system of Hemodynamics/Cardio Vascular 510, the associated diagnostic parameters of Mean Arterial Pressure (MAP) (15 points), Heart Rate (HR) (7 points), Hematocrit (HCT) (3 points), and ALBUMIN (11 points) are displayed. These APS points are generated using the APS calculation discussed above. Further, these APS points are assigned to each of the diagnostic parameters combine to form a value of 36, which is equivalent to the body-system score of Hemodynamics/Cardio Vascular 510. Accordingly, a viewer of the pop-up window 510 is able to expediently ascertain the diagnostic parameters that contribute the most to the APS, as well as the body-system score of Hemodynamics/Cardio Vascular 510.

For the body system of Central Nervous System/Nero 502, the associated diagnostic parameter of Presence/Absence of Medications Altering the Patient's Neurological Functioning (MEDS)/Glasgow Coma Score (GCS) (48 points) is displayed. Accordingly, APS points assigned MEDS/GCS comprise the only APS points that make up the body-system score for the Central Nervous System/Neuro 502. Thus, a viewer of the pop-up window 510 is able to expediently ascertain that only one diagnostic parameters is presently contributing to the body-system score of Central Nervous System/Nero 502.

For the body system of Renal 503, the associated diagnostic parameters of Urine Output (UOP) (15 points), Blood Urea Nitrogen (BUN) (12 points), and Creatinine (CREAT) (10 points) are displayed. Accordingly, the body-system score of 37 points for Renal 503 is derived from a combination of the APS points awarded to these diagnostic parameters.

For the body system of Hepatic/Metabolic 504, the associated diagnostic parameters of Bilirubin (BILI) (8 points), Sodium (NA) (2 points), and Glucose (GLUC) (0 points) are displayed. Accordingly, the body-system score of 10 points for Hepatic/Metabolic 504 is derived from a combination of the APS points awarded to these diagnostic parameters.

For the body system of Infectious Disease 505, the associated diagnostic parameters of Temperature (TEMP) (0 points) and White Blood Cell Count (WBC) (5 points) are displayed. Accordingly, the body-system score of 5 points for Infectious Disease 505 is derived from a combination of the APS points awarded to these diagnostic parameters.

For the body system of Pulmonary/Respiratory 506, the associated diagnostic parameters of Whether the Patient is Vented for the Respiratory Rate (VENTED) (0 points), Respiratory Rate (RR) (0 points), Arterial blood Gas Group (ABG) GROUP (0 points), and need to Acid-Base (not shown) are displayed. Accordingly, the body-system score of 0 points for Pulmonary/Respiratory 506 is derived from a combination of the APS points awarded to these diagnostic parameters. Further, is should be noted that even though the body-system score is 0, the pop-up window 510 still presents a representation of the non-deranged body system of Pulmonary/Respiratory 506. Further, the pop-up window 510 shows each of the APS scores even when some are associated with a null score.

In embodiments, the listing in the pop-up window 510 includes a percentage value associated with each of the body systems that indicates which proportion of the APS is driven by each physiological component. In embodiments, the percentage value is listed from highest to lowest in a priority order, thereby presenting the most deranged body systems closest to the top of the list. Accordingly, this priority order enables a physician to quickly ascertain which body system is the most deranged and what percent of the patient's APS is controlled by that body system.

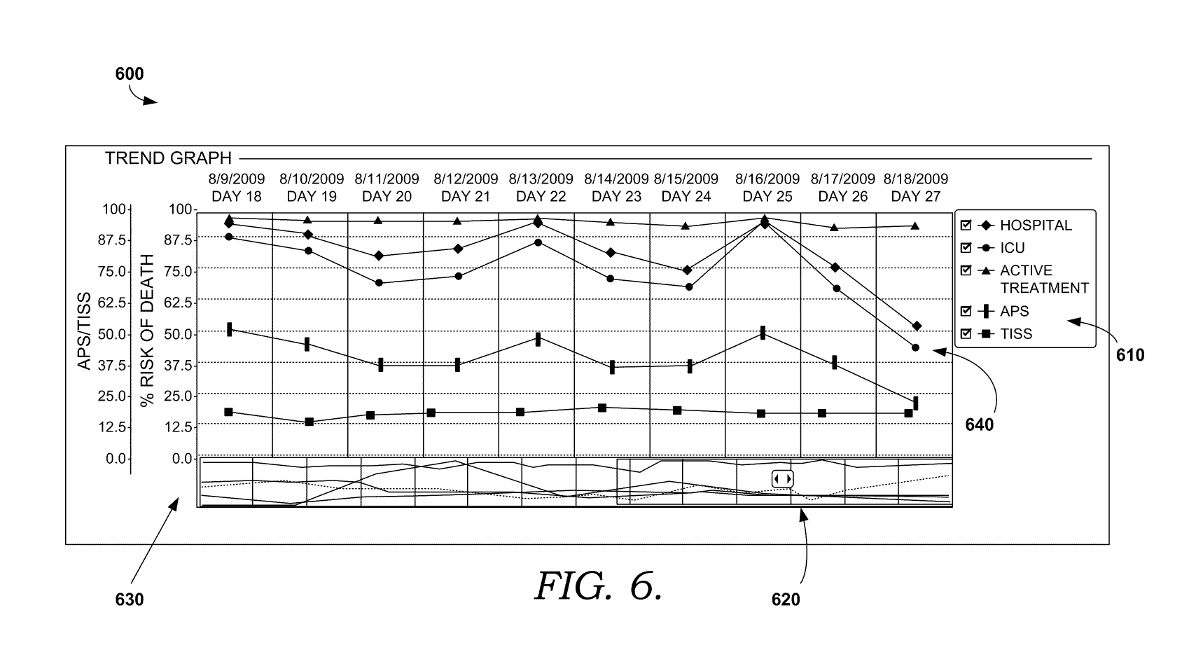

With reference to FIG. 6, an exemplary UI is shown, in accordance with embodiments of the present invention, that includes trend graph 600. The trend graph 600 may be invoked upon selecting a particular bed gadget, such as the bed gadget 300 of FIG. 5. The selection may involve any user operation, such as the touch-type user action or the hover action discussed above. Generally, the trend graph 600 includes a plurality of horizontal elements 640 that connect values calculated and plotted for each day. These values may be calculated by the analytical process or any other procedure that can be utilized to ascertain a risk of death and TISS. The trend graph 600, in embodiments, contains one entry, or value, for each ICU day. Once the patient is transferred out of an ICU setting or dies in the ICU, no more points will added to the graph. A key 610 is provided to expose what features (e.g., APS, risk of death, length of stay, and the like) each of the horizontal elements 640 are associated with. Further, a scope tool 620 is provided to adjust the range of days of a patient's stay in the ICU that are presented in the trend graph 600. In one instance, the scope tool may take the form of a slider bar.

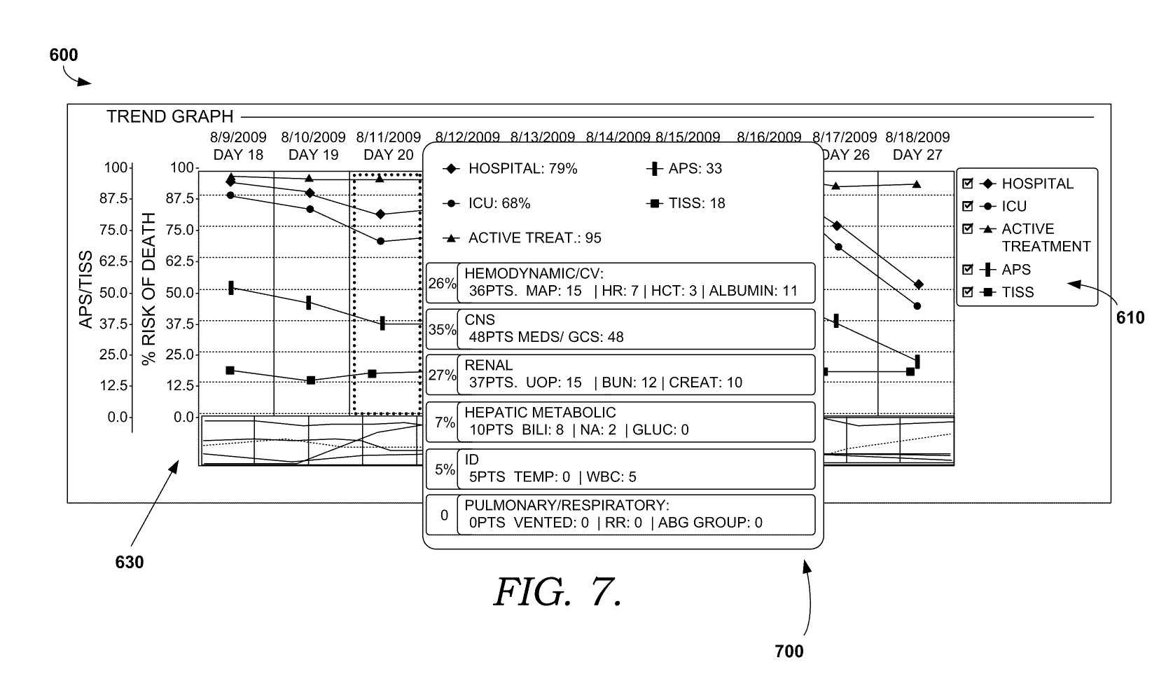

Referring to FIG. 7, an exemplary UI is shown, in accordance with embodiments of the present invention, that includes the trend graph 600 with a pop-up window invoked 700. Similar to the pop-up window 510 of FIG. 5, the pop-up window 700 may be invoked by any operation provided by a clinician via a user interface input, such as a touch-type user action within a target zone on a touchscreen, or a hover action of a mouse cursor over the bed gadget 300. Also, similar to the pop-up window 510 of FIG. 5, the display area of the pop-up window 700 is populated with a listing of the predefined body systems associated with the physiological components of the APS. However, the listing of the predefined body systems in the display area of the pop-up window 700 are provided with body-system scores and percentages of the APS that are computed for a particular day in the patient's stay history, as opposed to the current day that is broken down by point contributors in the pop-up window 510 of FIG. 5. In embodiments, the listing of the predefined body systems in the pop-up window 700 includes a percentage value associated with each of the body systems that indicates which proportion of the APS is driven by each body system. Further, the points awarded to each physiological component, designated as the body-system score, are presented. Further, still the points awarded to the diagnostic parameters grouped in each of the body systems are displayed within the display area of the pop-up window 700 in association with a physiological component. In addition, a key may be presented, similar to the key 610, within the pop-up window 700. As such, in conjunction with being provided with a real-time assessment of predicted patient risks and the patient's health status (i.e., provided on the bed-board display area that includes a layout of bed gadgets being dynamically updating), physicians can quickly navigate to a detailed graphical depiction of the history of the patient's present stay.

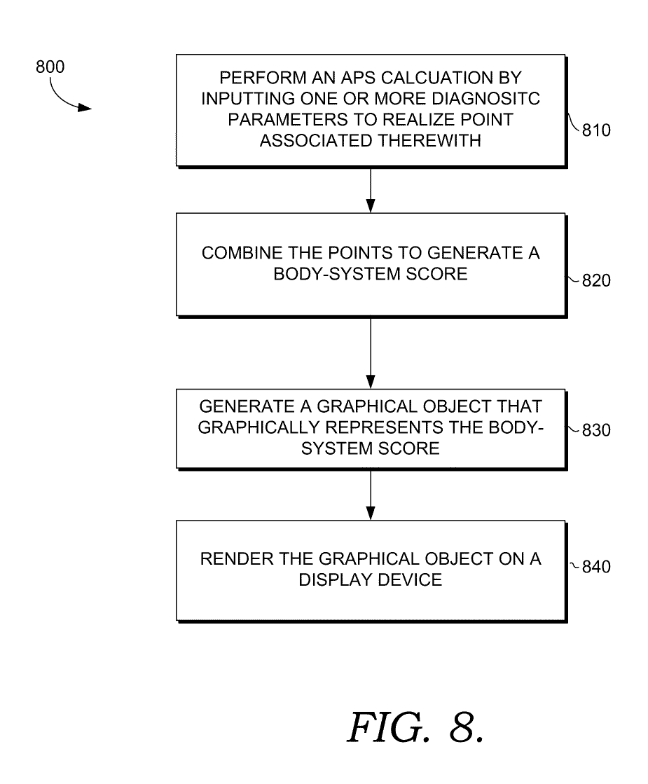

Turning to FIG. 8, an illustrative flow diagram of a method 800 for rendering a graphical object that visually presents those physiological components, which account for a patient's acute physiology, is shown, in accordance with an embodiment of the present invention. Further, when describing the flow diagram FIG. 8, although the terms “step,” “block,” and “process” are used hereinbelow to connote different elements of methods employed, the terms should not be interpreted as implying any particular order among or between various steps herein disclosed unless and except when the order of individual steps is explicitly described.

Initially, the method 800 includes the step of performing an acute physiology score calculation by inputting one or more diagnostic parameters to realize points associated with each of the diagnostic parameters, as indicated at block 810. Typically, the diagnostic parameters individually provide a measure of the patient's acute physiology. As indicated at block 820, the points are combined to generate at least one body-system score for each of the physiological components. As discussed above, the body-system score represents a value associated with each of the physiological components that can be used for monitoring a health status of a patient. Upon generating the body-system score, a graphical object that graphically represents the body-system score may be generated and displayed in an intuitive format (e.g., utilizing the rendering component 213 of FIG. 2), as indicated at block 830. In one instance, displaying may involve rendering the graphical object, in association with an indicia of the patient, on a display device. This step is indicated at block 840.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media accommodated by a computing device having computer-useable instructions embodied thereon that, when executed, perform a method for rendering a graphical object that visually presents those physiological components that account for a patient's acute physiology, wherein the method comprises:
performing an acute physiology score (APS) calculation by inputting one or more diagnostic parameters to realize points associated with each of the one or more diagnostic parameters, wherein the one or more diagnostic parameters individually provide a measure of the patient's acute physiology;
combining the points to generate at least one body-system score, wherein the at least one body-system score represents a value associated with each of the physiological components;
generating the graphical object that graphically represents the at least one body-system score, generated for each of the physiological components, in an intuitive format; and
rendering the graphical object, in association with an indicia of the patient, on a display device.

2. The computer-readable media of claim 1, wherein the method further comprises extracting relevant content from an electronic medical record (EMR) of the patient, wherein the relevant content includes the one or more diagnostic parameters that indicate recorded physical attributes of the patient.

3. The computer-readable media of claim 1, wherein the method further comprises:
utilizing medical devices to dynamically monitor the patient during an intensive care unit (ICU) stay; and
receiving data from the medical devices, wherein the data includes the one or more diagnostic parameters that describe a current status of the patient.

4. The computer-readable media of claim 1, wherein the method further comprises performing an admission assessment on the patient, wherein information gathered during the admission assessment includes the one or more diagnostic parameters that characterize a condition of the patient upon admittance to a hospital.

5. The computer-readable media of claim 1, wherein the physiological components are predefined in number and each correspond with a respective body system.

6. The computer-readable media of claim 5, wherein the method further comprises:
categorizing a selection of the one or more diagnostic parameters that measure a health of a particular body system into a group; and
associating the group of the one or more diagnostic parameters with one of the physiological components that corresponds with the particular body system.

7. The computer-readable media of claim 6, wherein combining the points to generate at least one body-system score comprises:
aggregating the points realized for each of the one or more diagnostic parameters that are members of the group associated with a particular physiological component; and
designating the aggregated points as the at least one body-system score associated with the particular physiological component.

8. The computer-readable media of claim 1, wherein performing an APS calculation comprises:
accessing a reference point associated with each of the one or more diagnostic parameters, wherein the reference point represents a benchmark measurement of an ICU patient;
iteratively ascertaining a deviation between each of the one or more diagnostic parameters and the associated reference point; and
awarding points to each of the one or more diagnostic parameters based on the deviation, wherein the greater the deviation, the higher the number of points awarded.

9. The computer-readable media of claim 8, wherein the reference point associated with each of the one or more diagnostic parameters and the points associated with each deviation are derived from a dynamically updated core dataset, wherein the core dataset computerizes experiences of a multitude of patients visiting an intensive care unit (ICU) by acquiring and analyzing treatment outcomes.

10. The computer-readable media of claim 1, wherein the method further comprises:
calculating an APS by adding the at least one body-system score associated with each of the physiological components together, wherein the APS provides an indication of an overall disease severity of the patient; and
rendering the APS in proximity with the graphical object on the display device.

11. The computer-readable media of claim 10, wherein the APS and the graphical object are rendered as content within a bed gadget, and wherein the bed gadget is assigned to a specific bed in either an ICU or a hospital.

12. The computer-readable media of claim 11, wherein the method further comprises:
calculating a predicted risk of death of the patient in the ICU and in the hospital based, in part, on the APS;
rendering a first graphical object that represents the predicted risk of death of the patient in the ICU as a percentage;
rendering a second graphical object that represents the predicted risk of death of the patient in the hospital as a percentage; and
presenting the first graphical object and the second graphical object within a display area of the bed gadget.

13. The computer-readable media of claim 12, wherein the method further comprises:
calculating a predicted length of stay of the patient in the ICU and in the hospital based, in part, on the APS;
rendering a third graphical object that represents the predicted length of stay of the patient in the ICU as a timeframe;
rendering a fourth graphical object that represents the predicted length of stay of the patient in the hospital as a timeframe; and
presenting the third graphical object and the fourth graphical object within the display area of the bed gadget.

14. The computer-readable media of claim 13, wherein the method further comprises visually coupling the predicted risk of death of the patient in the ICU and the predicted length of stay of the patient in the ICU by orientating the first graphical object and the third graphical object as a single block in a leftward portion of the display area.

15. The computer-readable media of claim 13, wherein the method further comprises visually coupling the predicted risk of death of the patient in the hospital and the predicted length of stay of the patient in the hospital by orientating the second graphical object and the fourth graphical object as a single block in a rightward portion of the display area.

16. A computer system for automatically tracking an inventory of beds residing in an intensive care unit (ICU) by calculating an acute physiological score (APS) for each adult patient that occupies one of the beds, the computer system comprising a processor coupled to a computer-readable medium, the computer-readable medium having stored thereon a plurality of computer software components executable by the processor, the computer software components comprising:
a receiving component to measure one or more diagnostic parameters of each patient that occupies one of the beds in the ICU, wherein the one or more diagnostic parameters indicate a health of a particular body system;
an APS computing component to perform an analytical process for calculating a body-system score associated with physiological components of the APS, wherein the analytical process comprises:
(a) realizing points associated with each of the one or more diagnostic parameters upon performing an APS calculation thereon;
(b) aggregating the points realized for each of the one or more diagnostic parameters that are members of a group, wherein the group is formed of the one or more diagnostic parameters that correspond with the particular body system; and
(c) designating the aggregated points as the body-system score associated with the one of the physiological components;
the APS computing component further configured to calculate the APS by adding the body-system score associated with each of the physiological components together, wherein the APS provides an indication of an overall disease severity of the patient;
a rendering component to render a bed gadget, wherein the bed gadget publishes the APS in proximity with a graphical representation of the body-system score associated with each of the physiological components.

17. The computer system of claim 16, wherein the rendering component is further configured to render the graphical object as a pie graph, wherein the pie graph is proportionally divided based on the body-system score associated with each of the physiological components.

18. The computer system of claim 17, wherein the rendering component is further configured to present a bed-board display that posts bed gadgets associated with each the beds in the ICU, respectively, and a key.

19. The computer system of claim 18, wherein each of the physiological components is assigned a consistent, non-repeating color, and wherein the key articulates which non-repeating color is assigned to each of the body systems associated with the physiologic components.

20. One or more computer-readable media having computer-executable instructions embodied thereon to present on one or more display devices a graphical user interface (GUI), the GUI being configured to present a plurality of bed gadgets that are each associated with one bed in an intensive care unit (ICU), the user interface comprising:
a bed-board display area that is populated with the plurality of bed gadgets representing each of the beds in the ICU,
wherein each of the plurality of bed gadgets publishes a pie graph that is proportionally divided according to values attached to physiological components,
wherein the physiological components are predefined in number, assigned a consistent, non-repeating color, and each correspond with a respective body system,
wherein the values attached to the physiological components are derived from comparatively evaluating a grouping of diagnostic parameters using an APS calculation,
wherein the diagnostic parameters individually provide a measure of the patient's acute physiology,
wherein the grouping is based on the respective body system being measured by the diagnostic parameters in the group; and
a key that articulates which consistent, non-repeating color is assigned to each of the body systems associated with the physiological components.
